(19) United States
(12) Patent Application Publication
(10) Pub. No.: US 2007/0256249 A1
(43) Pub. Date: Nov. 8, 2007

(54) FABRIC TREATING COMPOSITIONS CONTAINING ESTERQUAT WITH PERIODATE SALTS

(76) Inventors: Jean-Paul Grandmaire, Andrimont (BE); Leopold Laitem, Lebanon, NJ (US); Anita Hermosilla, Othee (BE)

Correspondence Address: COLGATE-PALMOLIVE COMPANY, 909 RIVER ROAD, PISCATAWAY, NJ, 08855, US

(21) Appl. No.: 11/744,280

(22) Filed: May 4, 2007

Related U.S. Application Data
(60) Provisional application No. 60/798,256, filed on May 5, 2006.

(51) Int. Cl. C11D 3/00

(52) U.S. Cl. 8/115.51

(57) ABSTRACT

Dispersible aqueous textile treatment compositions, such as fabric softeners, which include biodegradable quaternary ammonium fabric softener actives, and which exhibit excellent long-term storage stability, even where the storage is at elevated temperatures over long periods of time. The compositions comprise a biodegradable, fatty ester quaternary ammonium compound derived from the reaction of an alkanol amine and a fatty acid derivative, followed by quaternization; together with a periodate salt, such as potassium periodate.

### CROSS-REFERENCE TO RELATED APPLICATION

This application claims the benefit of U.S. Provisional Patent Application Ser. No. 60/798,256 filed May 5, 2006, the contents of which are incorporated herein by reference.

### BACKGROUND OF THE INVENTION

Compositions containing quaternary ammonium salts or imidazolinium compounds having at least one long chain hydrocarbyl group are commonly used to provide fabric treatment properties, particularly fabric softening benefits, when used in a laundry rinse operation.

More recently, in view of questions raised regarding the environmental safety (for example, biodegradability) of the quaternary compound softeners, as well as limits in the amounts of these cationic compounds which can be stably incorporated into the more convenient to use liquid formulations, there have been proposals for the partial or total replacement for conventional “quat” fabric softeners, which are exemplified by dimethyl distearyl or dimethyl ditallow ammonium chloride and various imidazolinium compounds.

Although the desirability of including in textile treating compositions, fabric softener materials containing biodegradable linkages is recognized, the unpredictable or unmanageable stability difficulties which can be raised by such materials in aqueous compositions upon extended periods of storage, particularly at high temperatures, has also been recognized. A number of solutions to obtain stability have been proposed; however, there remains a need in the art for alternative.

### SUMMARY OF THE INVENTION

Accordingly, the present invention provides stable, dispersible, textile treatment compositions comprising:
(a) about 1% to about 35% of a biodegradable fatty ester quaternary ammonium compound derived from the reaction of an alkaniol amine and a fatty acid derivative, followed by quaternization; and
(b) about 0.001% to about 1% of a periodate salt.

The composition may include other agents, as desired, including water, These compositions may be provided as ready-to-use products or as concentrates to be used at reduced levels, or which may be diluted with water prior to use at the same or similar levels as the ready-to-use products. The products may be used as textile treatment compositions during the fabric manufacturing process, or as fabric softener compositions in an in-home laundry context.

A quaternary ammonium compound useful in the defined compositions has the formula:

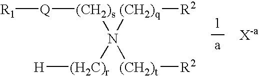

wherein Q is a carboxyl group having the structure selected from —OCO— and —COO; R¹ is an aliphatic hydrocarbon group having from 8-22 carbon atoms; R² is selected from Q-R¹ and OH; q, r, s, and t each independently represent a number from 1 to 3; and X^{-a} is an anion having a valence equal to “a”.

All percentages and ratios herein are intended to be “by weight” unless otherwise specified.

### DETAILED DESCRIPTION OF THE INVENTION

The present invention relates to dispersible aqueous textile treating compositions that comprise a biodegradable fatty ester quaternary ammonium compound, a periodate salt, and water. The compositions may also contain conventional additives found in fabric treating compositions for their regular and intended use, at their regular and intended usage levels. The compositions claimed encompass rinse-added fabric softener compositions which may be used in the home laundering process. In addition, they encompass compositions which are utilized in the textile manufacturing process for providing desirable finishes to fabrics. The compositions encompassed by the present invention also include compositions which are supplied to the user at usable strength, as well as compositions which are obtained as concentrates which then may be diluted to usable strength or may be applied in their concentrated form.

The quaternary ammonium softener material utilized in the compositions of the present invention is a biodegradable fatty acid quaternary ammonium compound known as an esterquat. These materials are present in the compositions of the present invention at about 1% to about 35% of the composition, preferably about 1% to about 25% of the composition, more preferably about 1% to about 10% of the composition. The esterquat materials are derived from the reaction of an alkanol amine and a fattv acid derivative, followed by quaternization (complete or partial) of the product. One embodiment of such esterquat materials has the following formula:

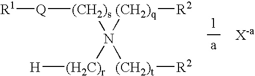

wherein Q is a carboxyl group having the structure selected from —OCO— and —COO; R¹ is an aliphatic hydrocarbon group having from 8 to 22 carbon atoms, preferably a C₁₀ to C₂₀ alkyl group; R² is selected from Q-R¹ and —OH; q, r, s, t each independently represent a number from 1 to 3; and X^{-a} is an anion having a valence “a”. Preferred anion materials include chloride, bromide, and methyl sulfate.

In one embodiment, these defined materials comprise a mixture of monoesters, diesters, and triesters. A specific embodiment of such materials is described in PCT Published Patent Application WO 2004/044113, Crutzen, published May 27, 2004, incorporated herein by reference. In such preferred mixture, the normalized percentage of monoester compound in said fatty ester quaternary ammonium compound is from 28% to 39%; the normalized percentage of diester compound is from 52% to 62%, and the normalized percentage of triester compound is from 7% to 14%, all percentages being by weight.

In another embodiment, the biodegradable fatty acid quaternary ammornium compound is an oligomeric esterquat, obtainable by reaction of an alkanol amine with (i) a polycarboxylic acid; and (ii) a fatty alcohol or a fatty acid or a mixture of fatty alcohols and fatty acids, followed by partial quaternization, thereby forming a mixture of oligomeric ester amines and esterquat. This material is described in U.S. Pat. No. 6,992,058, Grandmaire et al., issued Jan. 31, 2006, and European Published Application EP 1 136 471, both of which are incorporated herein by reference. In this material, it is preferred that the alkanol amine is triethanol amine. In a further preferred embodiment, the carboxylic acid is a polycarboxylic acid, more preferably a dicarboxylic acid. An example of such an esterquat material is commercially available from Kao Chemicals, under the tradename Tetranyl CL518.

Embodiments of the quaternary ammonium compounds useful in the present invention include those in which R¹ is C₁₀-C₂₀ alkyl. Further, in specific embodiments, one of the R² groups is Q-R¹. In another embodiment, both R² groups are Q-R¹. In a further embodiment, both R² groups are —OH.

Another component of the present invention is a periodate salt, which includes periodate-derived materials. The periodate salt is present at about 0.001% to about 1.0% of the textile treating composition by weight. Other embodiments of the present invention may incorporate the periodate salt at about 0.001% to about 0.1% of the composition by weight. An embodiment of the invention incorporates the quaternary ammonium material and the periodate salt at a quaternary ammonium/periodate molar ratio of about 1 to about 4. Examples of periodate salts useful in the present invention include potassium periodate, lithium periodate, sodium periodate and mixtures of those materials. A preferred material is potassium periodate.

The compositions of the present invention are water dispersions, such that the bulk of the balance of the composition is water. Generally, the composition will be acidic, having a pH of about 2 to about 6. Materials, such as acids or acid salts, can be added to the composition to control the pH of the composition. An example of a material that can be added is lactic acid. It is the acidity of the composition which makes it particularly important to stabilize the esterquat material.

Optional ingredients that are known in the art of treating textiles can be used to further improve the stability, the aesthetics, or the performance of the composition of this invention.

Perfumes may be added to enhance the freshness of the laundered clothing (or just to enhance the aesthetics of the composition itself).

The compositions of the invention often contain a fatty alcohol ethoxylate nonionic surfactant to emulsify the perfume present in the composition. The presence of an emulsifier ensures the physical stability of the composition which may otherwise be destabilized by the presence of perfume or fragrance in the composition. The fatty alcohol ethoxylates useful in the invention correspond to ethylene oxide condensation products of higher fatty alcohols, with the higher fatty alcohol containing about 9 to about 15 carbon atoms and the number of ethylene oxide groups per mole being about 5 to about 30.

As used herein, the term “perfume” is used in its ordinary sense to refer to and include any non-water soluble substance or a mixture of substances, including natural (i.e., obtained by extraction of flowers, herbs, blossoms, or plants), artificial (i.e., mixtures of natural oils or oil constituents), and synthetically produced odoriferous substances. Typically, perfumes are complex mixtures or blends of various organic compounds, such as alcohols, aldehydes, ethers, aromatic compounds, and varying amounts of essential oils (e.g., terpines), the essential oils themselves being volatile, odoriferous compounds, and also serving to dissolve the other components of the perfume.

In the present invention, the particular composition of the perfume is of no importance with regard to the performance of the liquid textile treating composition, so long as it can be incorporated into the composition and has a pleasing odor.

To prevent gelation of a concentrated liquid composition, the composition may contain a polyethylene glycol polymer or a polyethylene glycol alkyl ether polymer. The polyethylene glycol polymers as used herein, have a molecular weight of at least about 200, up to a molecular weight of about 8,000. Useful polymers include the polyethylene glycol methyl ether polymers marketed by Aldrich Chemical Company. Useful amounts of polymer in the compositions range about 0.1% to about 5% by weight. A range about 0.5% to about 1.5% by weight is preferred.

Examples of optional rheology modifiers and thickeners for use herein are well known in the art, and may be chosen from polymeric rheology modifiers and inorganic rheology modifiers. Examples of the former type include cationic polymers, such as copolymers of acrylamide and quaternary ammonium acrylate, and the like. Generally, only minor amounts, up to about 1%, preferably up to about 0.8%, such as, for example, about 0.1% to about 0.6%, by weight, provide acceptable viscosity levels over time.

Other optional co-softeners for use in the present invention are, for example, fatty alcohols, glycerol monostearate (GMS) and glycerol mono-oleate (GMO).

Other optional ingredients which may be used to reduce fabric wrinkling and enhance ease of ironing are nonionic humectants, inorganic salts, and film-forming polymeric materials, such as polyacrylates, polymethacrylates, silicones, starch derivatives, and polyolefin waxes.

Anti-dye transfer polymeric materials, such as polyvinyl pyrrolidone-type compounds may also be added to the present compositions.

Sequestering materials, such as poly phosphonates and polycarboxylic materials, can be used to neutralize water impurities, such as minerals (calcium, magnesium, copper), to protect the color of the clothes being laundered.

Other optional components commonly used in fabric softening compositions may be added in minor amounts to enhance either the appearance or performance properties of the liquid textile treating (fabric softener) compositions of the present invention. Typical components of this type include, but are not limited to, colorants (e.g., dyes or pigments), bluing agents, preservatives, germicides and perfumes.

The final product, whether in concentrated or diluted form, must be easily pourable by the end user. Generally, therefore, the final product viscosity (for a freshly prepared sample) should not exceed about 1500 centipoise, but should not be too low, for example, not less than about 50 centipoise. The preferred viscosity for the invention concentrated product is in the range of about 120 to about 1000 cps. As used herein, unless otherwise specified, viscosity is measured at 25° C. (22-26° C.) using a Brookfield RVTD digital viscometer with spindle #2 at 50 rpm.

Concentrated compositions may be diluted by a factor of generally 4:1, or more preferably up to about 8:1, or even 10:1. Concentrated products with up to about 35% softeners may be prepared and will remain pourable and stable against phase separation or suspended particle agglomeration for extended periods of time. For example, a composition with about 28% softeners can be diluted to about 5% active to provide equivalent or superior softening performance to a product containing about 7% of ditallow dimethyl ammonium chloride (DTDMAC). After dilution, or for a ready-to-use product the composition will normally contain sufficient softener to be effective when added to the rinse water in an amount of about ⅛ to ¾of a cup (1 to 6 ounces), providing about 50 ppm to about 250 ppm of the softener in the rinse water. Where the compositions are used in the textile manufacturing process, they are typically formulated at about 50 to about 250 ppm in an aqueous solution and applied (e.g., padded onto) the finished fabric, and dried.

The compositions of the present invention are able to provide additional benefits beyond fabric softening to fabrics and laundry, which are conditioned with such compositions. Principally, it is noted that these compositions can provide improved color protection by dye transfer inhibition to treated fabrics, as well as improved care benefits by minimizing fabric abrasion. This has the effect of enhancing fabric appearance and extending fabric longevity.

The compositions of the present invention are made by any means known or to be developed in the art.

The example illustrates the compositions of the present invention and the benefits provided by those compositions. The presence of the periodate salt in the compositions decreases the hydrolysis rate of the esterquat softening component and maintains the physical characteristics of the esterquat-containing fabric softener composition.

### EXAMPLE

A reference composition and a composition of the present invention, having the components set forth below, are made as follows:

TABLE 1

| | Content % |
|---|---|
| Reference Composition | |
| Water | QS to 100% |
| Esterquat | 4.5 |
| Perfume | 0.43 |
| Lactic Acid | 0.05 |
| Preservative | 0.2 |
| Thickener | 0.175 |
| Invention Composition | |
| Water | QS to 100% |
| Periodate-K | 0.0035 |
| Esterquat | 4.5 |
| Perfume | 0.43 |
| Lactic acid | 0.05 |
| Preservative | 0.2 |
| Thickener | 0.175 |

The hydrolysis rate of the esterquat component is determined by measuring the amount of free fatty acid generated by fatty ester of alkanol amine hydrolysis. Free fatty acid is determined by gas chromatograph analysis. The free fatty acids and free fatty alcohols are determined by capillary gas chromatography in the presence of pentadecanoid acid (C15:0) as internal standard. After solublization of the product in dimethyl formamide, the fatty acids and fatty alcohols are converted to their trimethyl silyl derivatives with BSTFA. Their levels are calculated by peak area integration with reference to previously determined response factors. The results of the free fatty acid determinations are reported in the following tables:

TABLE 2
REFERENCE

| | Aging Period (Weeks) | | | | |
|---|---|---|---|---|---|
| Temp. (° C.) | 0 | 4 | 8 | 16 | 22 |
| RT | 0.06 | — | 0.25 | — | 0.82 |
| 35 | 0.06 | — | 0.33 | 0.53 | 1 |
| 43 | 0.06 | 0.65 | — | — | 2.12 |
| 49 | 0.06 | 0.88 | 0.92 | 1.91 | 2.3 |

TABLE 3
PROTOTYPE

Aging Period (Weeks)

| Temp. (° C.) | 0 | 4 | 16 | 22 |
|---|---|---|---|---|
| RT | 0.56 | 0.6 | 0.64 | 0.61 |
| 35 | 0.56 | 0.64 | 0.6 | 0.8 |
| 49 | 0.56 | 0.7 | 0.75 | 1 |

The presence of free fatty acid is known to modify the aesthetics of a fabric softener product. The main characteristic affected is the viscosity of the product. The viscosity objective is to maintain the product fluid enough to be poured out of the container. The upper limit is about 800 cps after a 12 week aging at a maximum temperature of 43° C. These data show a clear decrease in the formation of free fatty acid (and, therefore, hydrolysis) in the presence of the periodate salt, particularly at the higher storage temperatures (43° C. and 49° C.).

What is claimed is:

1. A dispersible textile treatment composition comprising:
(a) about 1% to about 35% of a biodegradable fatty acid quaternary amnmxonium compound derived from the reaction of an alkanol amine and a fatty acid derivatives followed by quaternization; and
(b) about 0.001% to about 1% of a periodate salt.

2. The composition according to claim 1 wherein the quaternary ammonium compound has the formula: 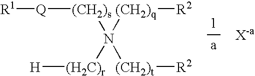
wherein Q is a carboxyl group having the structure selected from —OCO— and —COO—; R¹ is an aliphatic hydrocarbon group having 8 to 22 carbon atoms; R² is selected from -Q-R¹ and —OH; q, r, s, and t each independently represent a number from 1 to 3; and X^{-a} is an anion having a valence a.

3. The composition according to claim 2 which contains about 0.001% to about 0.5% of the periodate salt.

4. The composition according to claim 3 wherein a periodate salt is selected from potassium periodate, lithium periodate, calcium periodate, sodium periodate, and mixtures thereof.

5. The composition according to claim 4 wherein the periodate salt is potassium periodate.

6. The composition according to claim 4 wherein the molar ratio of quaternary ammonium compound/periodate is about 1 to about 4.

7. The composition according to claim 4 wherein the quaternary ammonium compound is a mixture of monoesters, diesters, and triesters.

8. The composition according to claim 7 wherein the normalized percentage of mono-ester in the fatty acid quaternary ammonium compound is about 28% to 39%, the normalized percentage of diester compound is about 52% to about 62%, and the normalized percentage of trimethyl compound is about 7% to about 14%.

9. The composition according to claim 1 wherein the quaternary ammonium compound is an oligomeric esterquat obtained by reaction of an alkanol amine with (i) a polycarboxylic acid; and (ii) a fatty alcohol, a fatty acid, or a mixture of fatty alcohol and fatty acid, followed by partial quaternization.

10. The composition according to claim 9 which contains about 0.001% to about 0.5% of a periodate salt selected from potassium periodate, calcium periodate, lithium periodate, sodium periodate, and mixtures thereof.

11. The composition according to claim 4 wherein, in the quaternary ammonium compound, R¹ is a C₁₀-C₂₀ alkyl.

12. The composition according to claim 11 wherein, in the quaternary ammonium compound, one of the R² groups is -Q-R¹.

13. The composition according to claim 11 wherein, in the quaternary ammonium compound, both R² groups are -Q-R¹.

14. The composition according to claim 11 wherein, in the quaternary ammonium compound, both R² groups are —OH.

15. A method of softening fabrics comprising placing said fabrics ill an aqueous solution comprising about 50 ppm to about 250 ppm of the composition according to claim 1.
